(19) United States
(12) Patent Application Publication
(10) Pub. No.: US 2022/0171657 A1
(43) Pub. Date: Jun. 2, 2022

(54) DYNAMIC WORKLOAD TUNING

(71) Applicant: International Business Machines Corporation, Armonk, NY (US)

(72) Inventors: Christof SCHMITT, Tucson, AZ (US); John T. OLSON, Tucson, AZ (US)

(21) Appl. No.: 17/108,301

(22) Filed: Dec. 1, 2020

(51) Int. Cl. G06F 9/50

(52) U.S. Cl. CPC G06F 9/5027

(57) ABSTRACT

Techniques are provided for dynamic workload tuning of a data pipeline that includes a plurality of stages, each associated with a respective storage element, a storage element monitor, and a resource manager. In one embodiment, the techniques involve the storage element monitor determining a utilization of a storage element associated with a first stage of the plurality of stages, comparing the utilization of the storage element to a first threshold, generating a signal based on the comparison of the storage element to the first threshold, output the signal; and the resource manager receiving the signal, determining that the signal indicates an increase or decrease of resources for the first stage, and adjusting compute resources for the first stage based on the signal in order to effect a change in the utilization of the storage element.

### BACKGROUND

The present invention relates to dynamically tuning data processing workloads, and more specifically, to optimizing resource distribution across stages of data pipelines based on buffer monitoring.

A data pipeline is a group of computing processes that uses, transfers, or transforms data. Each of these computing processes forms a stage in the pipeline such that the output of a first stage is passed as the input for a second stage.

One issue with traditional implementations of data pipelines arises when the first and second stages have different data throughput or workloads. If the throughput of the first stage is greater than the throughput of the second stage, and the workload differences of the first and second stages do not compensate for the differences in the throughputs, then the second stage may not be able to process all the data passed in from the first stage. This unprocessed data may be overwritten, or otherwise lost, whenever the first stage passes data beyond the throughput capabilities of the second stage.

Another issue with traditional implementations of data pipelines is that the throughput of the pipeline can be bottle-necked by the throughput and workload of any stage in the pipeline. That is, the speed at which each stage completes a task can be limited by its respective throughput capabilities, or by the amount of data received from the prior stage. The amount of data received from the prior stage can be limited by the throughput of the prior stage, or by the throughput of any stage that precedes the prior stage. Hence, a given stage can become a bottleneck for the throughput of subsequent stages, irrespective of the throughput capabilities of the subsequent stages. Therefore, if the throughput capabilities of the subsequent stages are greater than the throughput of the stage causing the bottleneck, then the pipeline may not run as efficiently as possible.

### SUMMARY

A system is provided according to one embodiment of the present disclosure. The system comprises a data pipeline including a plurality of stages, each associated with a respective storage element; a storage element monitor configured to: determine a utilization of a storage element associated with a first stage of the plurality of stages, compare the utilization of the storage element to a first threshold, generate a signal based on the comparison of the storage element to the first threshold, and output the signal; and a resource manager configured to: receive the signal, determine that the signal indicates an increase or decrease of resources for the first stage, and adjust compute resources for the first stage based on the signal in order to effect a change in the utilization of the storage element.

A method is provided according to one embodiment of the present disclosure. The method comprises determining, via a storage element monitor, a utilization of a storage element coupled to a first stage of a plurality of stages in a data pipe line; comparing, via the storage element monitor, the utilization of the storage element to a first threshold; generating, via the storage element monitor, a signal based on the comparison of the storage element to the first threshold; transferring, via the storage element monitor, the signal to a resource manager; determining, via the resource manager, that the signal indicates an increase or decrease of resources for a first stage; and adjusting compute resources for the first stage based on the signal in order to effect a change in the utilization of the storage element.

A computer-readable storage medium, which includes computer program code that performs an operation when executed on one or more computer processors, is provided according to one embodiment of the present disclosure. The operation comprises determining a utilization of a storage element coupled to a first stage of a plurality of stages in a data pipe line; comparing the utilization of the storage element to a first threshold; determining, based on the comparison, an increase or decrease of resources for a first stage; and adjusting compute resources for the first stage in order to effect a change in the utilization of the storage element.

### BRIEF DESCRIPTION OF THE SEVERAL VIEWS OF THE DRAWINGS

FIG. 1 illustrates a dynamic workload tuning system, according to one embodiment.

FIG. 2 illustrates a dynamic workload tuning system, according to one embodiment.

FIG. 3 depicts a flowchart of a method for implementing a storage element monitor, according to one embodiment.

FIG. 4 depicts a flowchart of a method for implementing a resource monitor, according to one embodiment.

FIG. 5 depicts a cloud computing environment, according to one embodiment.

FIG. 6 depicts abstraction model layers, according to one embodiment.

### DETAILED DESCRIPTION

Embodiments of the present disclosure are directed towards techniques for optimizing the data throughput of a data pipeline by monitoring the use of a storage element, and adjusting computing resources or processing priorities associated with stages of the pipeline based on their respective utilization of the storage element.

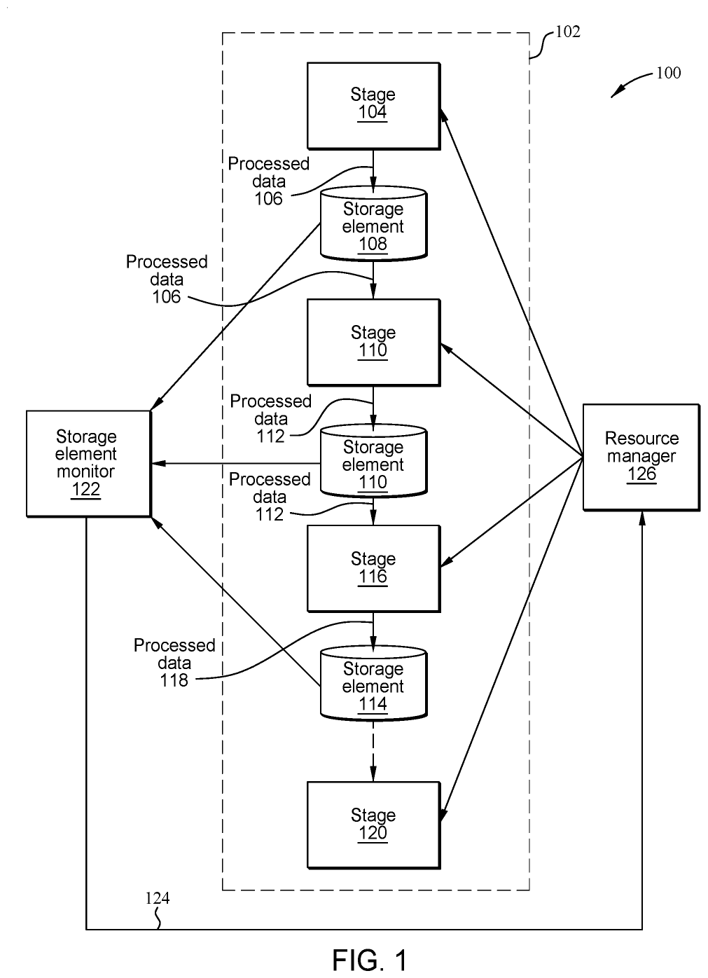

FIG. 1 illustrates a dynamic workload tuning system 100, according to one embodiment. The dynamic workload tuning system 100 optimizes the performance of data pipeline 102, which includes multiple stages and storage elements.

In one embodiment, each stage can be a process or task included in at least one of: an application, a cloud instance, a container, a virtual machine, or the like. The stages can be hosted on a single machine, or hosted on different machines coupled via a network. A given stage can receive data, process or transform the data, and transfer the processed or transformed data to a storage element.

Each storage element can be a buffer, computer file, database, flash memory device, hard-disk drive, shared file system, solid state drive, optical media, or the like. Further, a storage element can include memory that is physically separate from its associated stage. For example, the storage element can be coupled to a computer that is coupled to the stage via a bus or network.

In the illustrated embodiment, stage 104 can receive data from a database or other source (not shown), process the data, and write processed data 106 to storage element 108. Stage 110 receives the processed data 106 from storage element 108, further processes this data, and writes processed data 112 to storage element 114. Stage 116 receives the processed data 112 from storage element 114, further processes this data, and writes processed data 118 to storage element 120. A similar process occurs for stage 120, which receives data from a storage element, processes the data, and transfers the processed data to a computer (not shown).

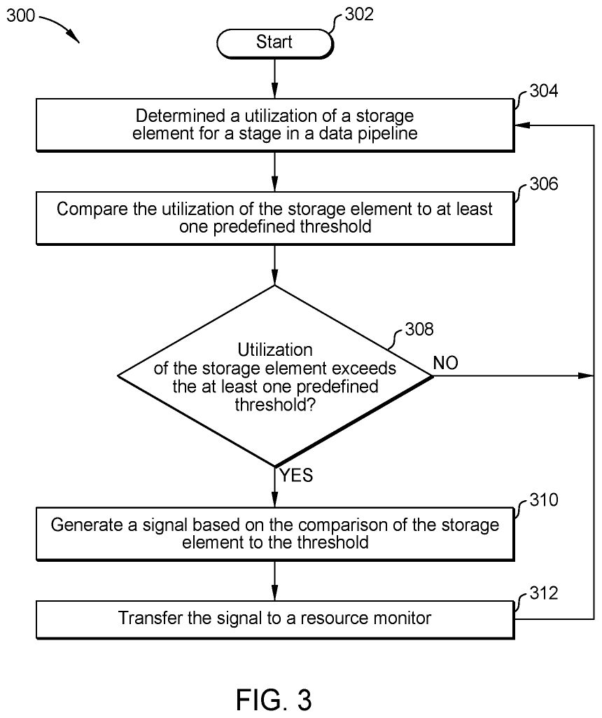

In one embodiment, storage element monitor 122 is a software module residing in a non-transitory computer readable medium. The storage element monitor 122 can evaluate usage of the storage elements of the data pipeline 102, generate a signal 124 based on a comparison of the usage to at least one threshold, and transfer the signal 124 to resource manager 126. The storage element monitor 122 can continuously monitor the storage elements to generate an updated signal 124 in real-time. For example, the storage elements may periodically, or at the request of the monitor 22, transmit updates indicating the amount of data they store. Operation of the storage element monitor 122 is described in further detail in FIG. 3.

In one embodiment, the resource manager 126 is a software module residing in a non-transitory computer readable medium. The resource manager 126 and the storage element monitor 122 may be hosted on the same computing system, or different computing systems. The resource manager 126 can receive the signal 124 generated by the storage element monitor 122, and use the signal 124 to adjust computing resources or processing priority of any stage in the data pipeline 102. Operation of the resource manager 126 is described in further detail in FIG. 7.

One benefit to the aforementioned dynamic workload tuning system is to optimize the data throughput of a data pipeline by ensuring that each stage of the pipe line has sufficient resource to avoid processing slowdowns and congestion of the data throughput.

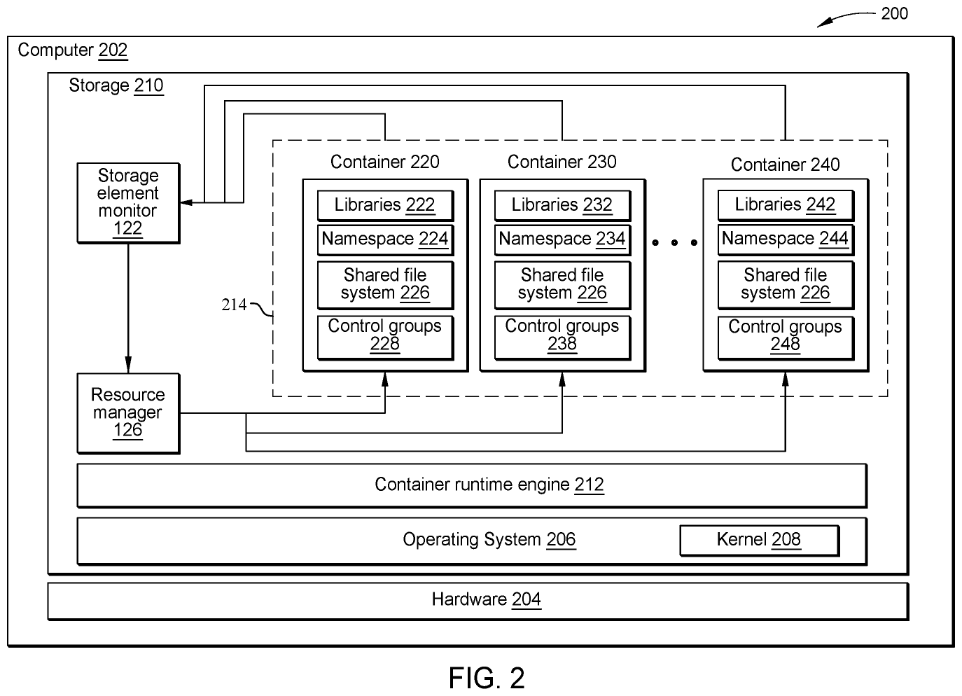

FIG. 2 illustrates a dynamic workload tuning system 200, according to one embodiment. FIG. 3 depicts a flowchart of a method 300 for implementing a storage element monitor, according to one embodiment. FIG. 2 is explained in conjunction with FIG. 3.

In the illustrated embodiment, the dynamic workload tuning system 200 optimizes the performance of data pipeline 214. The dynamic workload tuning system 200 can be hosted on a single computer 202. Not all components of the computer 202 are shown. The computer 202 comprises hardware 204, which generally includes a processor that obtains instructions and data via a bus from memory or storage 210. The processor is a programmable logic device that performs instruction, logic, and mathematical processing, and may be representative of one or more CPUs. The processor may execute one or more applications in memory or in storage 210. In one embodiment, the computer 202 can be one or more servers operating as a part of a server cluster. For example, computer 202 may operate as an application server and may communicate with or in conjunction with other frontend, application, backend, data repository, or other type of server.

The computer 202 is generally under the control of an operating system (OS) 206 suitable to perform the functions described herein. In at least one embodiment, the OS 206 allocates each program executing on the computer 202 a respective runtime stack. The computer 202 can include a kernel 208 that handles communication between the hardware 204 and computer readable instructions stored in the memory or storage 210.

The memory or storage 210 can be representative of hard-disk drives, solid state drives, flash memory devices, optical media, or the like. The memory or storage can also include structured storage, e.g. a database. In addition, the memory or storage may be considered to include memory physically located elsewhere; for example, on another computer coupled to the computer 202 via a bus or network.

As shown in FIG. 2, the storage 210 includes the data pipeline 214, which comprises multiple containers. Although each container is depicted as a single stage in the data pipeline 214, in one embodiment, each container can include multiple stages. In another embodiment, each stage includes at least one container.

In the illustrated embodiment, each container is a software module residing in the storage 210. Each container comprises libraries or binaries that allow the container to execute computer readable instructions without dependencies that are external to the container. Container 220 includes libraries 222, which are executed on the container runtime engine 212. Similarly, container 230 and container 240 include libraries 232 and libraries 242, respectively, which are executed on the container runtime engine 212.

Each container also comprises a namespace, which allows for an isolated container environment that can run a process isolated from any process of another container. Container 220 includes namespace 224, container 230 includes namespace 234, and container 240 includes namespace 244.

In this example, each container also has access to a file system that is shared with other containers in the data pipeline 214. The shared file system 226 can include at least one storage element that can be used by any container with access to the shared file system 226. In one embodiment, container 220, container 230, and container 240 can access the shared file system 226 to create, delete, read, write to, execute, or otherwise manipulate, a storage element stored on the shared file system 226. Non-limiting examples of storage elements include buffers, computer files, allocated or dedicated memory blocks and storage space, temporary memory or storage, and the like.

For example, if the data pipeline 214 is used to transcribe an audio stream, then container 220 can implement a speech recognition engine on the audio stream, create a first file (not shown) on the shared file system 226, and write a text transcription to the first file. Container 230 can then read the transcription from the first file, correct language issues in the text, create a second file (not shown) on the shared file system 226, and write the corrected text to the second file. Container 240 can then read the second file, translate the corrected text to other languages, create a third file (not shown) on the shared file system 226, and write the translated text to the third file.

Each container also comprises at least one control group associated with each process that runs in the container. In one embodiment, the control groups are created from a framework established by the kernel 208. The control groups can interface with the kernel 208 to control resources implemented for each container. These resources can include CPU cycles, GPU cycles, CPU or GPU processing priority, memory and storage 210 access and allotments, network bandwidth and traffic priority, other access to and use of the hardware 204, and the like.

A storage element monitor 122 can monitor the usage of at least one storage element of the shared file system 226, generate a signal that indicates the usage of the storage elements, and send the signal to a resource manager 126. In one embodiment, storage element monitor 122 is a software module residing in storage 210.

FIG. 3 depicts a flowchart of a method 300 for implementing a storage element monitor, according to one embodiment. The method beings at block 302.

At block 304, the storage element monitor determines a utilization of a storage element for a stage in a data pipeline. As mentioned above, the stages of data pipeline 214 comprise container 220, container 230, and container 230.

In one embodiment, the storage element monitor 122 receives a determination of the utilized capacity and remaining capacity from the operating system 206. In another embodiment, the remaining capacity can be determined from a calculation of the utilized capacity and a known size of the storage element. In yet another embodiment, when the storage element has a dynamic size (e.g., a computer file) that can grow as it receives input from a container, in comparison to a dedicated storage capacity (e.g., a static buffer or dedicated memory block), the remaining capacity can be determined from a calculation of the file size and an expected size of the file.

Continuing the example of transcribing an audio stream, assuming that each file has an expected file size, the storage element monitor 122 can continuously monitor the size of the first file, second file, or third file to determine the amount of data written to the files. The remaining capacity can be determined by subtracting the file sizes from their expected sizes. For instance, if the expected capacity of the first file is 100 MB, and the container outputs 90 MB to the storage element, then the remaining capacity is 10 MB.

In yet another embodiment, the remaining capacity of a storage element can be determined from a calculation of its utilized capacity and the amount of unused or non-overwritten storage capacity. For instance, if the containers in the above example write to buffers instead of files, then the storage element monitor 122 can determine the remaining capacity of each buffer by subtracting a measured utilized capacity from the buffer capacity.

At block 306, the storage element monitor 122 compares the utilization of the storage element to at least one predefined threshold. In one embodiment, the storage element monitor 122 compares the utilization to both a high threshold and a low threshold. The thresholds can be represented as a static capacity value (e.g., 1 MB), a relative value (e.g., 90% of the allotted or expected capacity), or a ratio (e.g., utilized capacity to allotted capacity).

At block 308, the storage element monitor 122 determines if the utilization of the storage element exceeds the thresholds of block 306. As a non-limiting example, the utilization of a storage element can exceed a high threshold when the utilized capacity is above 75% of the allotted storage capacity, while the utilization can exceed a low threshold when the utilized capacity is below 25% of the allotted storage capacity.

In one embodiment, a utilization of the storage element that exceeds the high threshold may indicate that the stage outputting data to the storage element does not have a high enough data throughput to avoid slowing slow the data throughput of the data pipeline. Similarly, a utilization of the storage element that exceeds the low threshold may indicate that the stage outputting data to the storage element has too many resources. Hence the extra resources are not being used optimally.

In another embodiment, more than two thresholds can be used to determine relative utilization amounts of the storage elements. As a non-limiting example, the high threshold can comprise three thresholds, such as 70%, 80%, or 90% of the allotted capacity of the storage element, while the low threshold can comprise three thresholds, such as 40%, 30%, or 20% of the allotted capacity of the storage element.

In one embodiment, if the utilization of the storage element does not exceed a threshold, the method 300 proceeds to block 304, where the storage element monitor determines a utilization of a storage element, as described above. In this embodiment, the storage element monitor does not generate a signal for the resource manager. If the utilization of the storage does not exceed a threshold, the method 300 proceeds to block 310.

At block 310, the storage element monitor 122 generates a signal based on the comparison of the storage element to the threshold. In one embodiment, the signal indicates that resources associated with the stage that outputs data to the storage element should be increased or decreased.

In another embodiment, if multiple thresholds can be used, then the signal can indicate relative adjustments of resources between stages in the pipeline. As a non-limiting example, if the high threshold comprises three sub-thresholds, such as 70%, 80%, or 90% of the allotted capacity of the storage element, then when a utilization of the storage element rises above the 70% threshold, the storage element monitor 122 can include code for a first flag in the signal. When a utilization of the storage element rises above the 80% threshold, the storage element monitor 122 can include code for a second flag in the signal. When a utilization of the storage element rises above the 90% threshold, the storage element monitor 122 can include code for a third flag in the signal. The flags can be used by the resource manager 126 to determine the relative amounts of resource adjustments to make for each stage.

A similar process can be used for a low threshold that comprises multiple thresholds. As a non-limiting example, if the low threshold comprises three sub-thresholds, such as 40%, 30%, or 20% of the allotted capacity of the storage element, then when a utilization of the storage element falls below the 40% threshold, the storage element monitor can include code for a fourth flag in the signal. When a utilization of the storage element falls below the 30% threshold, the storage element monitor can include code for a fifth flag in the signal. When a utilization of the storage element falls below the 20% threshold, the storage element monitor can include code for a sixth flag in the signal. The flags can be used by the resource manager to determine the relative amounts of resource adjustments to make for each stage.

At block 312, the storage element monitor 122 transfers the signal to a resource monitor 126, and proceeds to block 304. At block 304, the storage element monitor 122 determines another utilization of a storage element, as described above. In one embodiment, the method 300 is used to monitor each storage element in the pipeline in parallel.

Returning to FIG. 2, the resource manager 126 can use the signal to determine assignments or adjustments of resources for each container. In the illustrated embodiment, the resource manager 126 receives a signal from the storage element monitor 122 for each storage element that includes output from a container.

In one embodiment, each signal indicates whether resources should be increased or decreased for the respective stage. The resource manager 126 can use control groups to adjust the resources for the respective container. For instance, if the first signal indicates that resources should be increased for container 220, then the resource manager 126 can use control groups 228 to adjust resources such as CPU cycles, GPU cycles, CPU or GPU processing priority, memory and storage 210 access and allotments, network bandwidth and traffic priority, other access to and use of the hardware 204, associated with container 220. If the second signal indicates that resources should be decreased for container 230, then the resource manager 126 can use control groups 238 to adjust resources associated with container 230. If the third signal indicates that resources should be increased for container 240, then the resource manager 126 can use control groups 248 to adjust resources associated with container 240. In one embodiment, the operating system 206 ensures that the resource adjustments associated with the containers are within the bounds of resources available in the dynamic workload tuning system 200 environment.

In one embodiment, the resource manager adjusts resources for each stage upon determining that the signal associated with the stage indicates whether the resources should be increased or decreased. In another embodiment, when the signal includes multiple flags or indicators of multiple thresholds, the resource manager 126 can wait to receive multiple signals, and use the flags or indicators to determine relative amounts by which to allocate or adjust the resources among multiple stages. As a non-limiting example, if the flags indicate the extent that utilization of a storage element exceeds the high sub-thresholds (e.g., the first, second, and third flags indicate that the 70%, 80%, and 90% thresholds were exceeded, respectively), then the resource monitor 126 can compare the flags associated with each container. For instance, container 220 may have utilized a storage element enough to set the first flag (indicating over 70% capacity usage), container 230 may have utilized a storage element enough to set the second flag (indicating over 80% capacity usage), and container 240 may have utilized a storage element enough to set the first flag (indicating over 70% capacity usage). Hence, the resource monitor 126 can determine that container 230 is associated with the flag that indicates the greatest utilization of the storage elements, and allocate more resources to container 230, than to container 220 or container 240. A similar process can be used for sub-thresholds of the low threshold.

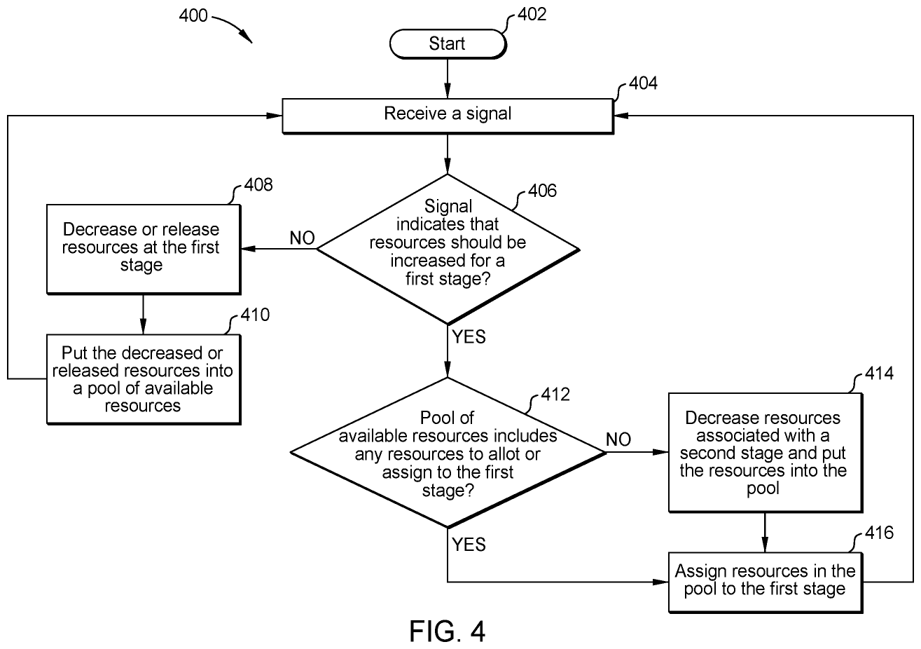

FIG. 4 depicts a flowchart of a method 400 for implementing a resource monitor, according to one embodiment. The method begin at block 402.

At block 404, the resource monitor receives a signal. In one embodiment, the signal is generated by a storage element monitor when a utilization of a storage element rises above a first threshold or falls below a second threshold. In one embodiment, the signal can include a storage element utilization rank for an associated stage. In one embodiment, the storage element monitor does not generate a signal when the utilization of the storage element does not rise above the first threshold or fall below the second thresholds.

At block 406, the resource manager determines whether the signal indicates that resources should be increased or decreased for a first stage. In one embodiment, the signal includes an alert, notification, software flag, or the like, as an indicator for resource adjustment or allotment at the first stage.

If the resource manager determines that resources for the first stage should be decreased, then the method 400 proceeds to block 408. At block 408, the resource manager decreases or releases resources at the first stage. At block 410, the resource manager puts the decreased or released resources into a pool of available resources. The method 400 continues to block 404, where resource manager receives another signal, as described above.

Returning to block 406, if the resource manager determines that resources for the first stage should be increased, then the method 400 proceeds to block 412. At block 412, the resource manager determines if the pool of available resources includes any resources to allot or assign to the first stage. If the pool includes any resources, then the method 400 proceeds to block 416, where the resources in the pool are assigned to the first stage. If the pool does not include any resources, then the method 400 proceeds to block 414 where resources associated with a second stage are decreased and put into the pool. At block 416, the resources in the pool are assigned to the first stage. The method 400 continues to block 404, where resource manager receives another signal, as described above.

As mentioned above, the signal can include a storage element utilization rank for the associated stage. In one embodiment, the resource manager can use the utilization rank to apportion resources from the pool among multiple stages in accordance with the rank associated with the stage. As a non-limiting example, if a utilization of the storage element of a first stage is 10% of the capacity of the storage element, then a first signal can include a utilization rank of 1. If a utilization of the storage element of a second stage is 50% of the capacity of the storage element, then a second signal can include a utilization rank of 5. If a utilization of the storage element of a third stage is 50% of the capacity of the storage element, then a third signal can include a utilization rank of 5. If a utilization of the storage element of a fourth stage is 70% of the capacity of the storage element, then a third signal can include a utilization rank of 7. In this scenario, upon receiving the first signal, the resource manager can determine that the first signal includes a utilization rank, and wait for more signals with utilization ranks. When the resource manager has received a predefined number of signals or waited for a predefined period of time, the resource manager can use the signals to adjust resources at each stage such that the fourth stage receives most of the available resources; the second and third stages receive an equal amount of available resources that is less that the amount given to the fourth stage; and the first stage receives no additional resources. A similar process can be used to decrease the resources at each stage in relative amounts.

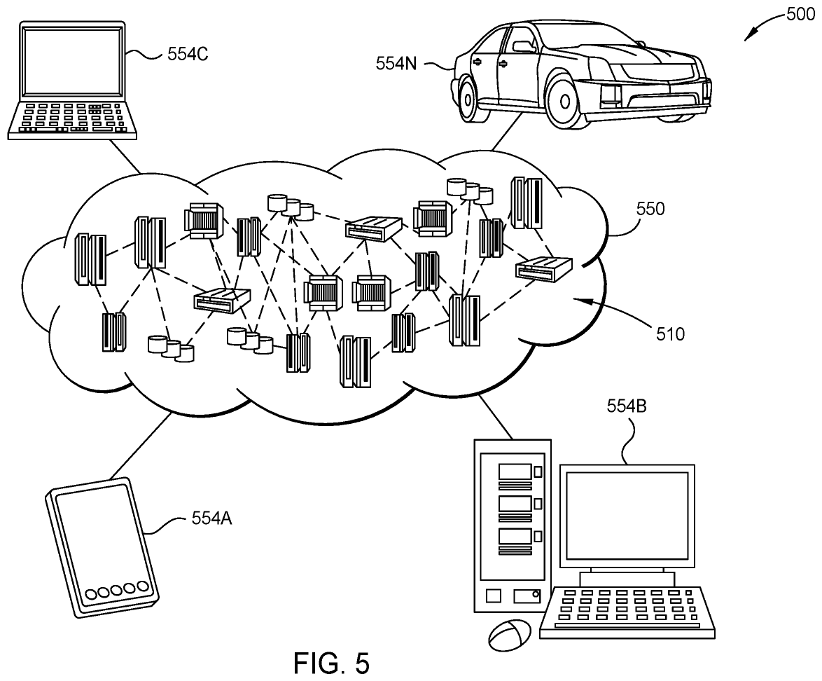

Referring now to FIG. 5, illustrative cloud computing environment 550 is depicted. As shown, cloud computing environment 550 includes one or more cloud computing nodes 410 with which local computing devices used by cloud consumers, such as, for example, personal digital assistant (PDA) or cellular telephone 554A, desktop computer 554B, laptop computer 554C, and/or automobile computer system 554N may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 5 are intended to be illustrative only and that computing nodes 510 and cloud computing environment 550 can communicate with any type of computerized device over any type of network and/or network addressable connection (e.g., using a web browser).

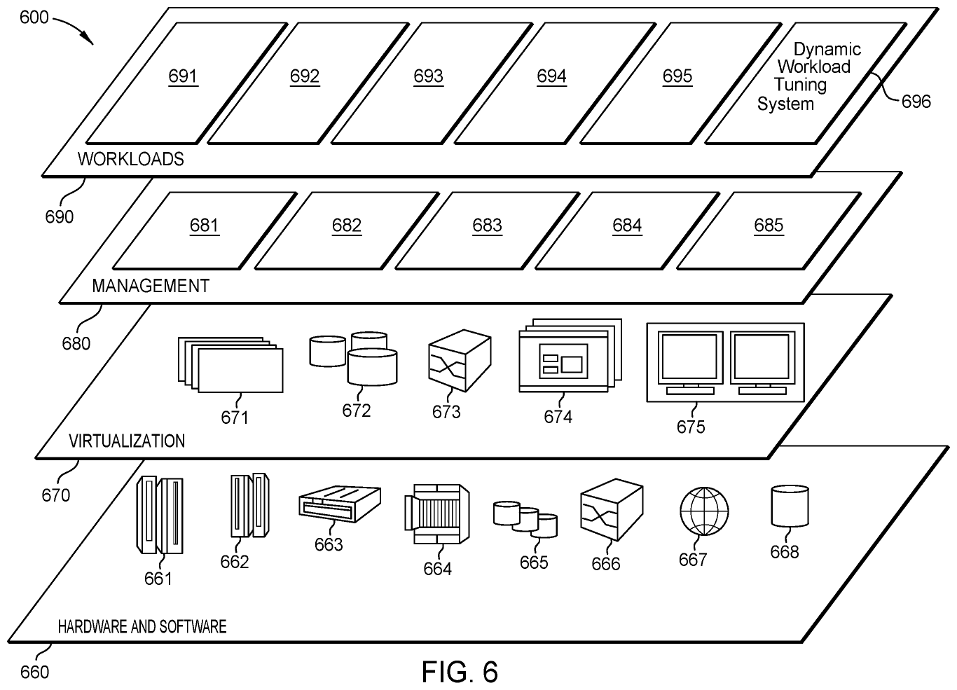

Referring now to FIG. 6, a set of functional abstraction layers provided by cloud computing environment 550 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

Virtualization layer 670 provides an abstraction layer from which the following examples of virtual entities may be provided: virtual servers 671; virtual storage 672; virtual networks 673, including virtual private networks; virtual applications and operating systems 674; and virtual clients 675.

In one example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and a dynamic workload tuning system 696.

In one embodiment, the dynamic workload tuning system comprises a data pipeline, a storage element monitor, and a resource manager. The data pipeline can include multiple stages and storage elements. Each stage can be a process or task included in at least one of: an application, a cloud instance, a container, a virtual machine, or the like. The stages can be hosted on a single machine, or hosted on different machines coupled via a network. A given stage can receive data, process or transform the data, and transfer the processed or transformed data to a storage element. Each storage element can be a buffer, computer file, or other storage of the hardware and software layer 660 or virtual storage 672.

In one embodiment, the storage element monitor is a software module residing in storage of the hardware or software layer 660 or virtual storage 672. The storage element monitor can evaluate usage of the storage elements of the data pipeline, generate a signal based on a comparison of the usage to at least one threshold, and transfer the signal to the resource manager. The storage element monitor can continuously monitor the storage elements to generate an updated signal in real-time.

In one embodiment, the resource manager is a software module residing in storage of the hardware or software layer 660 or virtual storage 672. The resource manager can receive the signal generated by the storage element monitor, and use the signal to adjust resources of any stage in the data pipeline. In one embodiment, the resources of a stage can be adjusted by changing a parameter for a cloud instance hosting the stage, or by invoking a billing API of the cloud to request an increase or decrease of resources for the cloud instance.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

While the foregoing is directed to embodiments of the present invention, other and further embodiments of the invention may be devised without departing from the basic scope thereof, and the scope thereof is determined by the claims that follow.

What is claimed is:

1. A system comprising:
a data pipeline including a plurality of stages, each associated with a respective storage element;
a storage element monitor configured to:
determine a utilization of a storage element associated with a first stage of the plurality of stages,
compare the utilization of the storage element to a first threshold,
generate a signal based on the comparison of the storage element to the first threshold, and
output the signal; and
a resource manager configured to:
receive the signal,
determine that the signal indicates an increase or decrease of resources for the first stage, and
adjust compute resources for the first stage based on the signal in order to effect a change in the utilization of the storage element.

2. The system of claim 1, wherein the first stage receives data, processes or transforms the data, and transfers the processed or transformed data to the storage element, and wherein a second stage receives data from the storage element, processes or transforms the data, and transfers the processed or transformed data to another storage element or to the resource manager.

3. The system of claim 1, further comprising comparing the utilization of the storage element to a second threshold.

4. The system of claim 3, wherein the signal indicates an increase of resources for the first stage when the utilization of the storage element exceeds the first threshold, and the signal indicates a decrease of resources for the first stage when the utilization of the storage element does not exceed the second threshold.

5. The system of claim 1, wherein the resource manager is further configured to:
determine that the signal includes a ranking or indication of priority associated with the first stage;
receive a predefined amount of signals; and
upon receiving the signals, adjust resources for stages associated with the signals based on the ranking or indication of priority.

6. The system of claim 1, wherein the first stage comprises a process or task included in at least one of: an application, a cloud instance, a container, and a virtual machine.

7. The system of claim 1, wherein the storage element comprises at least one of: a buffer, computer file, database, file system, memory block, memory device, optical media, storage device, and virtual storage.

8. The system of claim 1, wherein the resources comprise at least one of: a cloud instance parameter, CPU cycle, GPU cycle, CPU or GPU processing priority, memory or storage access or allotment, network bandwidth, and network traffic priority.

9. A method comprising:
determining, via a storage element monitor, a utilization of a storage element coupled to a first stage of a plurality of stages in a data pipe line;
comparing, via the storage element monitor, the utilization of the storage element to a first threshold;
generating, via the storage element monitor, a signal based on the comparison of the storage element to the first threshold;
transferring, via the storage element monitor, the signal to a resource manager;
determining, via the resource manager, that the signal indicates an increase or decrease of resources for a first stage; and
adjusting compute resources for the first stage based on the signal in order to effect a change in the utilization of the storage element.

10. The method of claim 9, wherein the first stage receives data, processes or transforms the data, and transfers the processed or transformed data to the storage element, and a second stage receives data from the storage element, processes or transforms the data, and transfers the processed or transformed data to another storage element or to the resource manager.

11. The method of claim 9, further comprising comparing the utilization of the storage element to a second threshold.

12. The method of claim 11, wherein the signal indicates an increase of resources for the first stage when the utilization of the storage element exceeds the first threshold, and the signal indicates a decrease of resources for the first stage when the utilization of the storage element does not exceed the second threshold.

13. The method of claim 9, further comprising:
determining, via the resource manager, that the signal includes a ranking or indication of priority associated with the first stage;
receiving, via the resource manager, a predefined amount of signals; and
upon receiving the signals, adjusting, via the resource manager, resources for stages associated with the signals based on the ranking or indication of priority.

14. The method of claim 9, wherein the first stage comprises a process or task included in at least one of: an application, a cloud instance, a container, and a virtual machine.

15. The method of claim 9, wherein the storage element comprises at least one of: a buffer, computer file, database, file system, memory block, memory device, optical media, storage device, and virtual storage.

16. The method of claim 15, wherein the resources comprise at least one of: a cloud instance parameter, CPU cycle, GPU cycle, CPU or GPU processing priority, memory or storage access or allotment, network bandwidth, and network traffic priority.

17. A computer-readable storage medium including computer program code that, when executed on one or more computer processors, performs an operation, the operation comprising:
determining a utilization of a storage element coupled to a first stage of a plurality of stages in a data pipe line;
comparing the utilization of the storage element to a first threshold;
determining, based on the comparison, an increase or decrease of compute resources for a first stage; and
adjusting compute resources for the first stage in order to effect a change in the utilization of the storage element.

18. The computer-readable storage medium of claim 17, wherein the operation further comprises:
upon determining the increase of resources for the first stage, determining that a pool of available resources does not include any resources available for assignment to the first stage;
decreasing resources of a second stage of the data pipeline; and
assigning the resources in the pool to the first stage.

19. The computer-readable storage medium of claim 17, wherein the operation further comprises: upon determining a decrease of resources for the first stage, releasing resources to a pool of available resources.

20. The computer-readable storage medium of claim 17, wherein the operation further comprises:
determining a ranking or indication of priority associated with the first stage;
determining a ranking or indication of priority associated with a second stage; and
adjusting resources for the first and second stages based on the ranking or indication of priority.
